(19) United States
(12) Patent Application Publication
(10) Pub. No.: US 2005/0021851 A1
(43) Pub. Date: Jan. 27, 2005

(54) System, apparatus, and method for directional control input browsing in smart phones

(76) Inventor: Kimmo Hamynen, Espoo (FI)

Correspondence Address: Crawford Maunu PLLC, Suite 390, 1270 Northland Drive, St. Paul, MN, 55120, US

(21) Appl. No.: 10/457,805

(22) Filed: Jun. 9, 2003

(51) Int. Cl. G06F 15/16

(52) U.S. Cl. 709/245; 715/501.1

(57) ABSTRACT

A system, apparatus, and method for facilitating browsing sessions on a mobile terminal using directional control input using joystick, voice, or acceleration/tilt command input. Navigation between Web pages and menus is conducted by pre-selecting corresponding navigation tabs using directional input and activating the Web pages and menus using activation inputs. Navigation of oversized Web pages is also facilitated by directional control input. A first mode of screen navigation renders the hypertext document into sub-frames, where each sub-frame is accessed using directional navigation commands. A second mode of screen navigation uses a directionally controlled scrolling window to display portions of the hypertext document. Once a Web page, or a portion of a Web page is activated, interaction with the Web page content is facilitated through directional control input.

### FIELD OF THE INVENTION

This invention relates in general to hypertext document navigation, and more particularly, to hypertext document navigation in mobile devices having limited viewing area and limited resources with which to provide navigation command input.

### BACKGROUND OF THE INVENTION

The mobile industry has experienced a period of exceptional growth during the past several years, where mobile voice and simple Short Message Service (SMS) text messaging have provided the primary drivers for this growth. The next wave of growth is expected to come from new mobile services where content, not just voice, will be mobilized. To insure a successful launch of these new mobile services, service enablers are used to create the mobile services according to at least the following criteria: enablement of new and better services for consumers; provision of facilities to developers to speed up the development of the mobile services; and insuring interoperability through the use of open global standards.

The use of open global standards, such as those endorsed by the Open Mobile Alliance (OMA), minimizes fragmentation of the service enablers and insures seamless interoperability between different vendors. Some of the key service enablers used for the successful take-up of the mobile services include: Multimedia Messaging Service (MMS); Mobile Digital Rights Management (MDRM); and mobile browsing, to name only a few.

The essence of mobile browsing lies in its close alignment with widely accepted internet standards. The Wireless Application Protocol (WAP) Forum and the World Wide Web Consortium (W3C) have successfully defined mobile internet standards over the past several years. Just recently, the WAP Forum has adopted the Extensible HyperText Markup Language (XHTML) Basic standard from the W3C as the basis for the latest revision of WAP. The transition to XHTML Basic will strengthen the position of the mobile browser in the mainstream Internet and allow for a far greater range of presentation and formatting than previously possible.

The essential elements of browsing content includes: a page description language; a content formatting language; and a scripting language. These elements enable consumers to enjoy a wider array of services, more intuitive user interfaces, and a generally more useful experience. At the same time, carriers will be able to exercise more control over the look and feel of services they provide through their mobile portals. According to the W3C specification, XHTML Basic defines a document type that is rich enough to be used for content authoring and precise document layout, yet can be shared across different classes of devices, such as desktop computers, Personal Digital Assistants (PDA), TV, mobile devices, etc.

One of the many challenges presented by mobile browsing, however, is the usability of the User Interface (UI) that is currently provided in prior art mobile terminals. The UI provided in prior art mobile terminals is menu driven, thus requiring an extensive amount of user interaction through a combination of key press and drop down menu selection. The user is so inundated with menu and key selection choices, in fact, that the browsing function facilitated by prior art mobile terminals is almost unmanageable.

Additionally, the display size limitation of the mobile device is a severe hindrance to the user's browsing experience. Frame presentation to certain mobile devices, as it is known in the art, is not practical because of the horizontal and vertical size limitations imposed by the mobile device display. Mobile device access to an HTML frame that has been rendered for a desktop browser, for example, allows only a portion of the frame to be viewed at any given time by the mobile device. Accordingly, navigation throughout the frame entails a series of vertical and horizontal scrolling movements that requires a high degree of laborious interaction by the user.

Other document/presentation formats designed for larger displays pose problems for the mobile display as well. For example, document formats such as Portable Document Format (PDF), Macromedia Flash, Synchronized Multimedia Integration Language (SMIL), Scalable Vector Graphics (SVG), etc. may not allow rendering of the document to fit within the constraints of the mobile device display. Rendering in some cases would, for example, break up the original layout and structure of the document. User interaction, therefore, is required to navigate within the document.

Mobile devices that are designed for one-hand operation, however, do not provide for navigational input devices such as stylus/touch screen, mouse pointer, virtual cursor, etc. Rather, navigational keys or joysticks that allow directional commands are all that may be offered on the mobile terminal. Prior art methods to navigate within these larger documents using the one-handed mobile terminals, therefore, require the user to “tab” over to the next hyperlink/hotspot contained within the documents using their navigational keys. For larger documents, however, “tabbing” to each and every hyperlink/hotspot within the document is laborious and time consuming.

Additionally, link navigation poses additional demands on the mobile terminal user as many of the most popular navigational commands are hidden behind drop down menu selections. Actions such as previous page, next page, short cuts, go to page, and bookmarks are not conveniently located within a one or two button UI operation. Instead, the user may have to traverse many different sub-levels of menu options before arriving at the desired operation.

Accordingly, there is a need in the communications industry for a system, apparatus, and method that facilitates simplified browser operation using mobile terminals that do not have pointing capability. In particular, an improved UI is required that facilitates execution of the most popular browser operations by using simple joystick commands. Additionally, a convenient method is required to simultaneously navigate within a page and select hyperlinks without the need for pointing devices. Additionally, a need exists that allows navigation of all hyperlinks within an electronic document from the first to the last, while simultaneously allowing page scrolling without the need for a pointing device.

### SUMMARY OF THE INVENTION

To overcome limitations in the prior art, and to overcome other limitations that will become apparent upon reading and understanding the present specification, the present invention discloses a system, apparatus, and method for navigating electronic documents using a reduced size, mobile device display without the use of pointing devices. More particularly, navigation is facilitated through the exclusive use of a joystick without the need to utilize the limited functionality of menu keys.

In accordance with one embodiment of the invention, a network browsing system is provided. The network browsing system comprises a network having Web pages addressable by a Uniform Resource Locator (URL) and a mobile terminal coupled to the network. The mobile terminal comprises a mobile browser coupled to receive markup definitions associated with the Web pages and arranged to generate content frames from the markup definitions and navigation tabs corresponding to the content frames. The mobile terminal further comprises a navigational device coupled to the mobile browser, wherein directional inputs from the navigational device pre-selects the navigation tabs and depression inputs from the navigational device activates the content frames.

In accordance with another embodiment of the invention, a mobile terminal wirelessly coupled to a network having Web pages accessible by a Uniform Resource Locator (URL) is provided. The mobile terminal comprises a memory capable of storing at least one of a mobile browser and a rendering module, a transceiver configured by the mobile browser to facilitate markup language exchange with a plurality of Web pages, a processor coupled to the memory and configured to render navigation tabs corresponding to the Web pages, and a navigation device coupled to pre-select the navigation tabs using directional input and coupled to activate the Web pages with depression input.

In accordance with another embodiment of the invention, a computer-readable medium having instructions stored thereon which are executable by a mobile terminal for facilitating browser navigation is provided. The instructions perform steps comprising receiving documents containing hyperlinks, generating a navigation frame to display navigation tabs relating to the documents, generating a content frame to display content relating to the navigation tabs, and navigating within the navigation and content frames, wherein pre-select feedback corresponding to directional input is provided and activation feedback is provided corresponding to selection input.

In accordance with another embodiment of the invention, a method for facilitating joystick navigation on a mobile terminal is provided. The method comprises detecting direction and depression inputs from a joystick, correlating the joystick inputs with a relative position on a browser window, interpreting the joystick inputs as navigational when correlated to a first portion of the browser window, and interpreting the joystick inputs as interactive when correlated to a second portion of the browser window.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates an exemplary communication system in which the principles of the present invention may be utilized;

FIG. 2 illustrates browsing command access by navigation through prior art menu options;

FIGS. 3-5 illustrate various embodiments of browsing control implemented with a joystick in accordance with the present invention;

FIG. 6 illustrates an exemplary document rendering that may be navigated in accordance with the present invention;

FIG. 7 illustrates an alternative document rendering that may be navigated in accordance with the present invention;

FIG. 8 illustrates an exemplary content window that may be displayed in accordance with the present invention;

FIG. 9 illustrates an alternative document rendering that may be navigated in accordance with the present invention;

FIG. 10 illustrates an exemplary content window that may be displayed in accordance with the present invention;

FIG. 11 illustrates an exemplary flow diagram in accordance with the present invention; and

FIG. 12 illustrates a representative mobile computing arrangement suitable for navigating Web pages in accordance with the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system, apparatus, and method that allows users of mobile terminals to browse electronic content conveniently and effortlessly by using joystick commands, or alternately, through the use of voice or acceleration/tilt command input. The UI of the present invention seeks to provide the user with configurable browsing options that provides browsing capability to the user exclusively through directional command input. As such, the present invention allows efficient, straightforward, and pleasurable browsing operations for today's mobile terminal user.

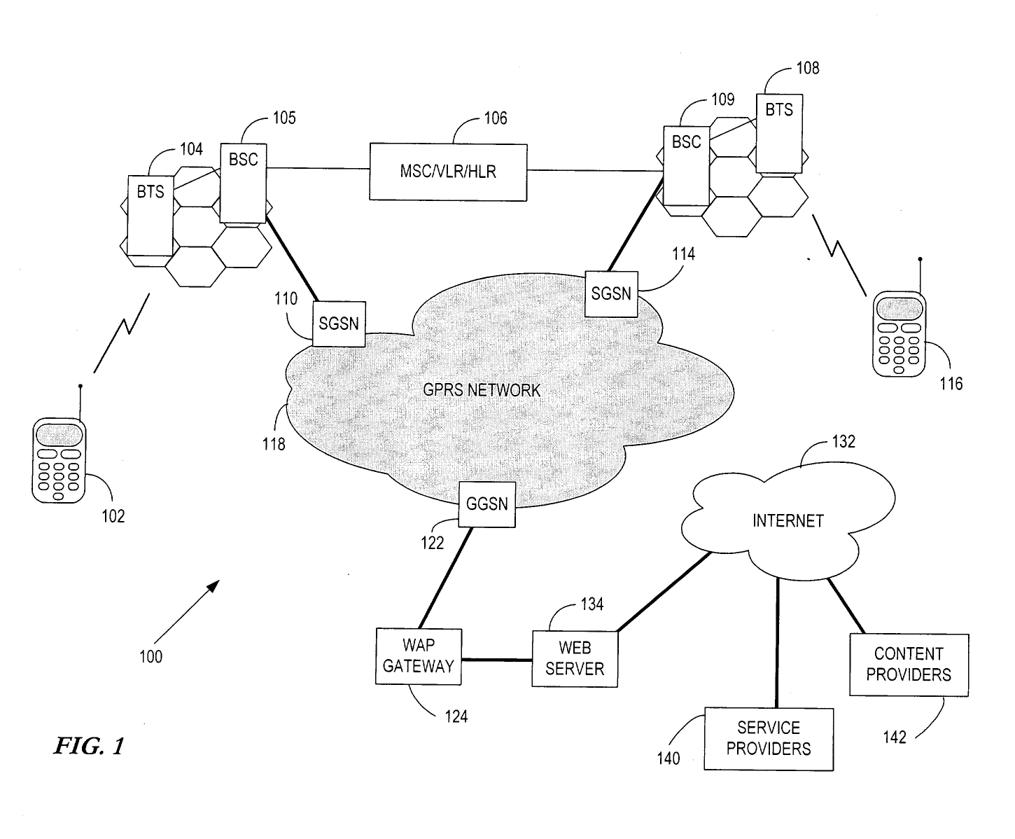

FIG. 1 illustrates exemplary communication system 100 in which the principles of the present invention may be utilized. Communication system 100 utilizes General Packet Radio Service (GPRS) network 118 as the communications backbone. GPRS is a packet-switched service for the Global System for Mobile Communications (GSM) that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. While the exemplary embodiments of FIG. 1 are generally described in connection with GPRS/GSM, it should be recognized that the specific references to GSM and GPRS are provided to facilitate an understanding of the invention. As will be readily apparent to those skilled in the art from the description provided herein, the invention is equally applicable to other technologies, including other circuit-switched and packet-switched technologies, 3G technologies, and beyond.

Referring to FIG. 1, mobile terminals 102 and 116 communicate with Base Transceiver Station (BTS) 104 and 108, respectively, via an air interface. BTS 104 and 108 are components of the wireless network access infrastructure that terminates the air interface over which subscriber traffic is communicated to and from mobile terminals 102 and 116. Base Station Controller (BSC) 105 and 109 are switching modules that provide, among other things, handoff functions, and power level control in each BTS 104 and 108, respectively. BSC 105 and 109 controls the interface between a Mobile Switching Center (MSC) 106 and BTS 104 and 108, and thus controls one or more BTSs in the call set-up functions, signaling, and use of radio channels. BSC 105 and 109 also controls the respective interfaces between Serving GPRS Support Node (SGSN) 110 and BTS 104 and SGSN 114 and BTS 108.

SGSN 110 serves a GPRS mobile terminal by sending or receiving packets via a Base Station Subsystem (BSS), and more particularly via BSC 105 and 109 in the context of GSM systems. SGSN 110 and 114 are responsible for the delivery of data packets to and from mobile terminals 102 and 116, respectively, within the service area, and they perform packet routing and transfer, mobility management, logical link management, authentication, charging functions, etc. In the exemplary GPRS embodiment shown in FIG. 1, the location register of SGSN 110 stores location information such as the current cell and Visiting Location Register (VLR) associated with mobile terminal 102, as well as user profiles such as the International Mobile Subscriber Identity Number (IMSI) of all GPRS users registered with SGSN 110. SGSN 114 performs similar functions relating to mobile terminal 116. While GSM forms the underlying technology, SGSN 110 and 114 described above are network elements introduced through GPRS technology. Another network element introduced in the GPRS context is the Gateway GPRS Support Node (GGSN) 122, which acts as a gateway between the GPRS network 118 and WAP gateway 124. Access to Internet 132 and corresponding service and content providers, 140 and 142 respectively, is provided to mobile terminals 102 and 116 via Web server 134.

WAP enhances the functionality of mobile terminals through real-time interactive services. The protocol has been specifically designed for small screens and low bandwidths, and it offers a wide variety of wireless services over the Internet for mobile devices. It was also designed to allow content to be delivered over any bearer service, even when delivery of the services is enabled over GPRS, 3G, or any other type of network. WAP over GPRS opens up new possibilities for application development and there are also some optimizations in GPRS that can be performed by service developers.

Application developers can use the principles of WAP to develop new services or adapt existing Internet applications for use with mobile devices. Applications are written in Wireless Markup Language (WML) and WMLScript (WMLS) and are stored on either Web server 134 or directly on WAP gateway 124. The content stored on Web server 134 is accessible from mobile devices 102 and 116 via GPRS network 118, GGSN 122, and WAP gateway 124. It is recommended to use a HyperText Transfer Protocol (HTTP) proxy (not shown) to cache WML content whenever the content is accessed via Internet 132. The proxy should either be co-located with WAP gateway 124 or proximately located next to WAP gateway 124 in order to minimize the delay in data transfer between the two components.

Mobile devices 102 and 116 access WAP gateway 124 using a GSM data call, where they supply a user-agent field within a Wireless Session Protocol (WSP) header when fetching content from Web server 134. WAP gateway 124 then encapsulates the WSP header within an HTTP header prior to sending to Web server 134. The WSP header is utilized by Web server 134 to, for example, determine the particular browser that is being utilized by mobile devices 102 and 116, so that suitable content may be delivered to mobile devices 102 and 116 by Web server 134.

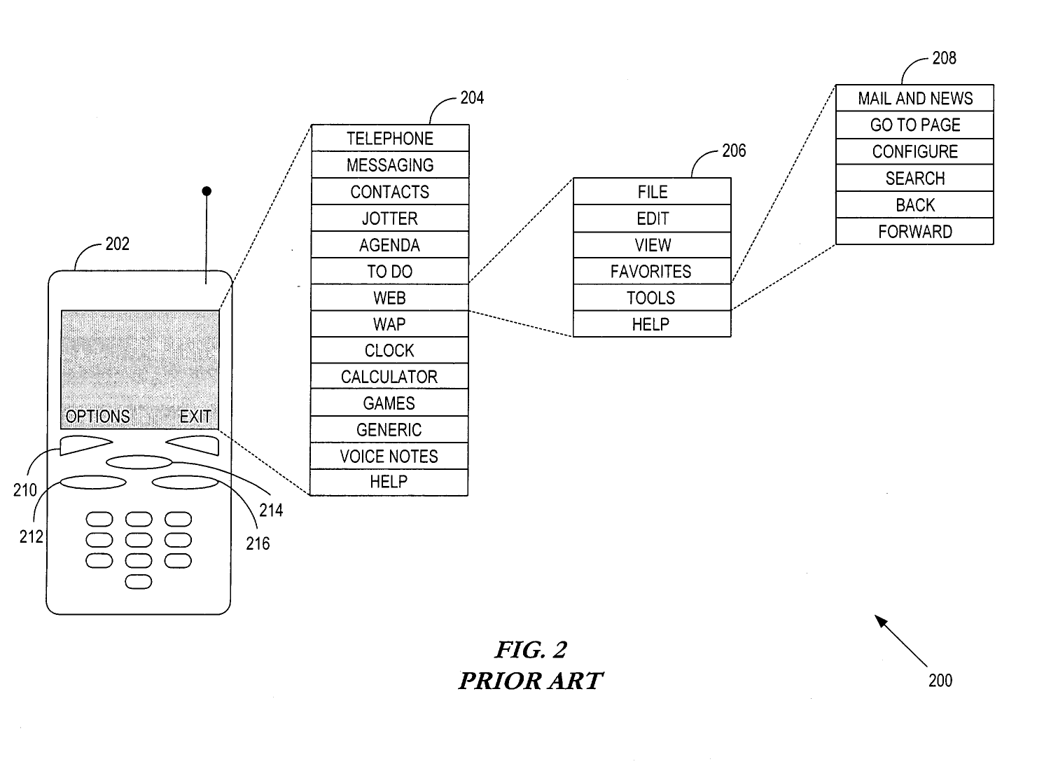

During the course of a browsing session, the users of mobile devices 102 and 116 may visit several Web pages which are pointed to by Uniform Resource Locators (URLs). The visited URLs may have been preloaded into bookmarks, found through the use of search engines, located by direct access, etc. Prior art mobile terminals, however, do not provide the user with the facilities to manage a complete browsing session through exclusive use of directional controls, e.g., joystick control. Rather, the prior art mobile terminal of FIG. 2, for example, illustrates menu option access 200 that may be required to complete the user's current browsing needs.

The user of prior art mobile terminal 202 must, for example, navigate through 2 sub-menus 204 and 206 before arriving at sub-menu 208, in order to obtain the Web browsing tools necessary for a prior art browsing session. By pressing options key 210 once, sub-menu 204 pops up to allow user interaction with the 14 options of sub-menu 204. By pressing either up key 212 or down key 216, one of the 14 options of sub-menu 204 may be highlighted and ultimately selected by pressing select key 214.

For example, once sub-menu 204 is instantiated, option “TELEPHONE” may be the highlighted option of sub-menu 204, whereby 6 key presses of down key 216 highlights option “WEB”. One key press of select key 214 instantiates the “WEB” sub-menu 206, followed by 4 subsequent key presses of down key 216 highlights option “TOOLS” of WEB sub-menu 206. One press of select key 214 instantiates TOOLS sub-menu 208, that allows the user to search for URLs using the “SEARCH” option or directly type in a URL using the “GO TO PAGE” option. Navigation tools “BACK” and “FORWARD” are also provided to the user to facilitate browsing. It can be readily seen, therefore, that a considerable number of key presses are required to navigate between sub-menus 204-208 to allow the user to initiate and sustain a browsing session.

The advantages of the present invention, however, enables the user to efficiently and effortlessly navigate the browsing session using directional inputs to include: locating URLs; locating specific information contained within oversized Web pages existing at those URLs; and interacting with the Web pages all with one-hand operation from a joystick mounted on the mobile terminal. It should be noted that while illustration of directional input is provided by joystick control, other forms of directional input may also be used in accordance with the present invention. In one embodiment for example, directional input may be provided using voice commands such as “navigate up”, “navigate down”, “navigate left”, or “navigate right”. In another embodiment for example, the user may tilt the mobile terminal itself in order to input acceleration/tilt commands for navigational control.

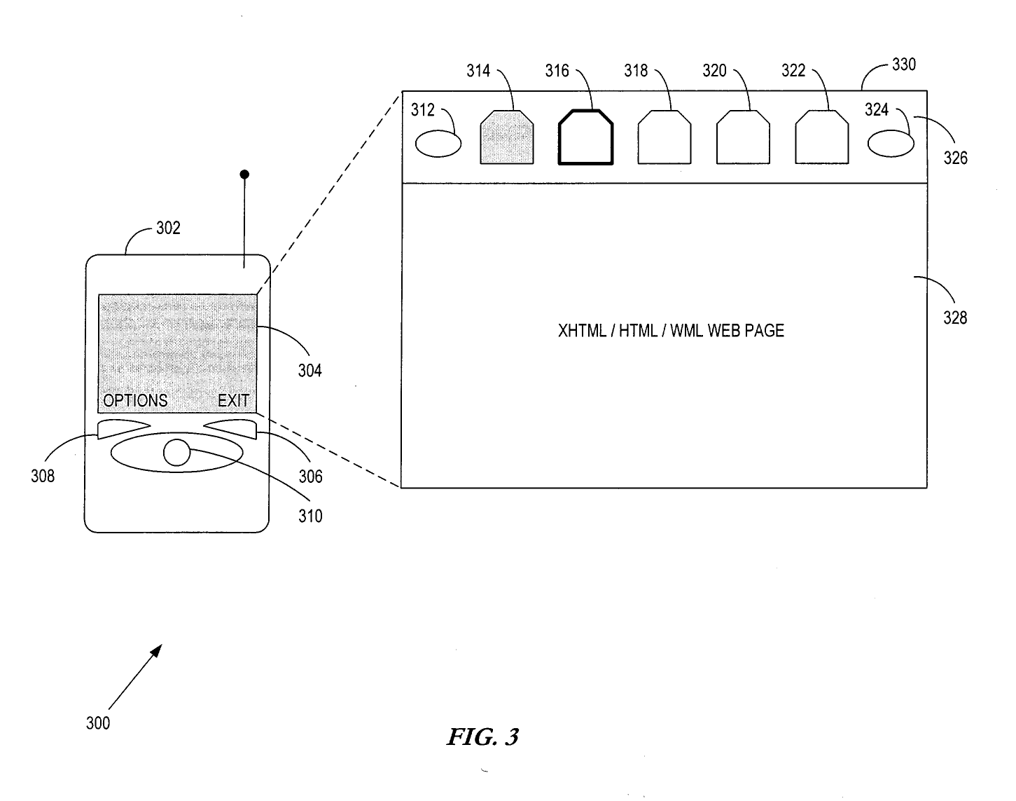

FIG. 3 illustrates exemplary diagram 300 illustrating mobile terminal display 304 of mobile terminal 302 during a typical browsing session in accordance with the present invention. Mobile terminal, or Smartphone, 302 represents a primarily communication-oriented device having limited means to input, process, store and transfer data, yet possesses integrated features that promote efficient computation. The core of mobile terminal 302 is its operating system platform, e.g., the Symbian Operating System platform. The Symbian platform consists of: an operating system; a set of applications; support for different means of communication, e.g., voice, messaging, and browsing; support for Personal Computer (PC) connections; a framework for a Graphical User Interface (GUI); an application architecture framework; and application development support.

To cope with the many different form factors of mobile terminal 302, Symbian has defined different Device Family Reference Designs (DFRD) with different Input/Output (I/O) capabilities such as required for joystick 310, left selection key 308, and right selection key 306. The DFRDs enable the reuse of components within the same device family, the sharing of system resources and binary compatibility between different devices belonging to the same device family. In addition to the operating system, the Symbian platform provides an application suite for the most common PDA applications, such as Personal Information Management (PIM), messaging, office applications and more.

The UI framework eases the development and porting of applications and enables the applications to have the same look and feel as native applications. At the same time, the application architecture supports the development of document-centric and task oriented applications. To support the development of further applications, the Symbian platform also contains Software Development Kits (SDKs) for applications written in C++ or Java as well as tools for the development of applications allowing a connection to a PC.

One such task oriented application executing within mobile terminal 302 is one whose browser operation is exemplified by display 330. Display 330 provides exemplary browser output frames 326 and 328, where frame 326 provides navigational control and feedback to the user of mobile terminal 302, while frame 328 provides the contents of the Web page, or portion of the Web page, activated by navigation tabs 314-322. In particular, each of navigation tabs 314-322 represents a URL of a Web page hosted by, for example, Internet 132 of FIG. 1. Activation of navigation tabs 314-322 by the user allows the Web page, or a portion of the Web page, pointed to by the URL associated with the activated navigation tab to be displayed in content frame 328. Once a navigation tab has been activated, visual feedback is provided to the user by noticeably discoloring the activated navigation tab to a darker shade of gray, or color, as compared to the other non-activated navigation tabs in navigation frame 326.

In operation, for example, navigation tab 314 is the currently activated navigation tab and content frame 328 displays the Web page, or a portion of the Web page, pointed to by the URL associated with navigation tab 314. As such, navigation tab 314 is shaded darker than navigation tabs 316-322, in order to provide the user with instantaneous feedback as to which content frame is currently active. In order to highlight and pre-select other navigation tabs 316-322, the user of mobile terminal 302 merely is required to actuate joystick 310 left or right in accordance with his or her navigational wishes. For example, if the user wishes to visit the URL represented by navigation tab 316, the user actuates joystick 310 one instance to the right. In response, a visual feedback mechanism, e.g. a browsing cursor, is employed to indicate that navigation tab 316 is the current position of the browsing cursor. The browsing cursor may be a visual indication that includes highlighting just the borders of navigation tab 316, e.g., as illustrated in FIG. 3, blinking navigation tab 316 on/off, or other visual/tactile feedback mechanisms sufficient to indicate the browsing cursor's position. If the user wishes to view the content represented by navigation tab 316, the user then depresses joystick 310 one time. In response, the browser executing within mobile terminal 302 then contacts the URL associated with navigation tab 316 and displays the URL's contents, or a portion thereof, onto content frame 328. In like manner, the user of mobile terminal 302 is able to navigate between navigation tabs 314-322 to activate any content of interest that is represented by them.

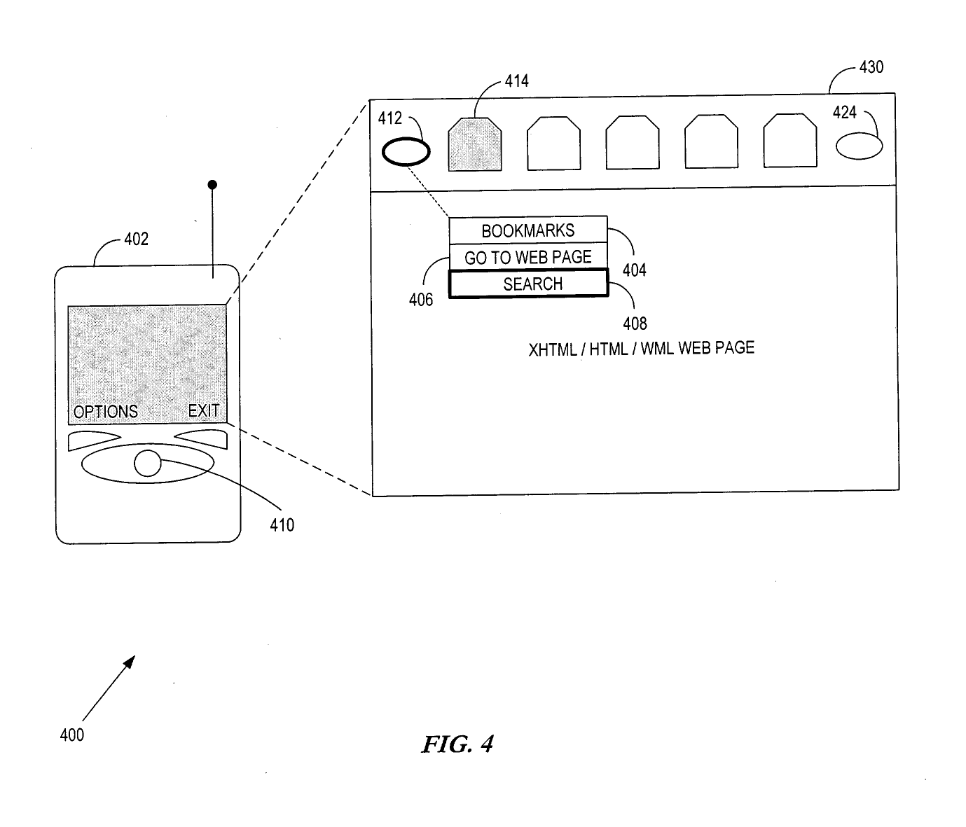

In addition, other features of the browser are easily accessed by feature tabs 412 and 424, as illustrated by diagram 400 of FIG. 4. The user of mobile terminal 402, for example, is currently viewing the content represented by navigation tab 414, as indicated by the darkened state of navigation tab 414. One actuation of joystick 410 to the left, however, causes the browsing cursor to highlight the borders of feature tab 412 and also causes a pop up window having menu selections 404-408 to be presented. Once the pop up window has been instantiated, the user may then cycle through each menu selection 404-408 using separate upward or downward actuations of joystick 410. As each menu option is traversed, the browsing cursor supplies visual feedback to the user, e.g. darkened borders, to instantaneously allow the user to ascertain his or her navigational position within display 430. Menu selection 404, for example, allows the user the ability to perform bookmarking operations on URLs that have been previously bookmarked, URLs to be bookmarked, or the deletion of old bookmarks as necessary. Likewise, menu selection 406, for example, allows the user to provide textual input to define a particular URL of interest. Still further, menu option 408, for example, allows the invocation of a search engine to allow URLs to be accessed by keyword association.

Feature tab 424 may offer identical menu selections as those offered by feature tab 412, or may alternately provide other menu options that are configurable by the user. For example, one menu option offered by feature tab 424 may provide a history of all URLs visited within the last configurable number of days. Additionally, feature tab 424 may offer a menu selection that allows the user to configure browser options such as the default home page displayed by the content window upon instantiation of the browser, a content advisor to help control the content type displayed by the browser, and other options as necessary to completely configure the operation of the browser.

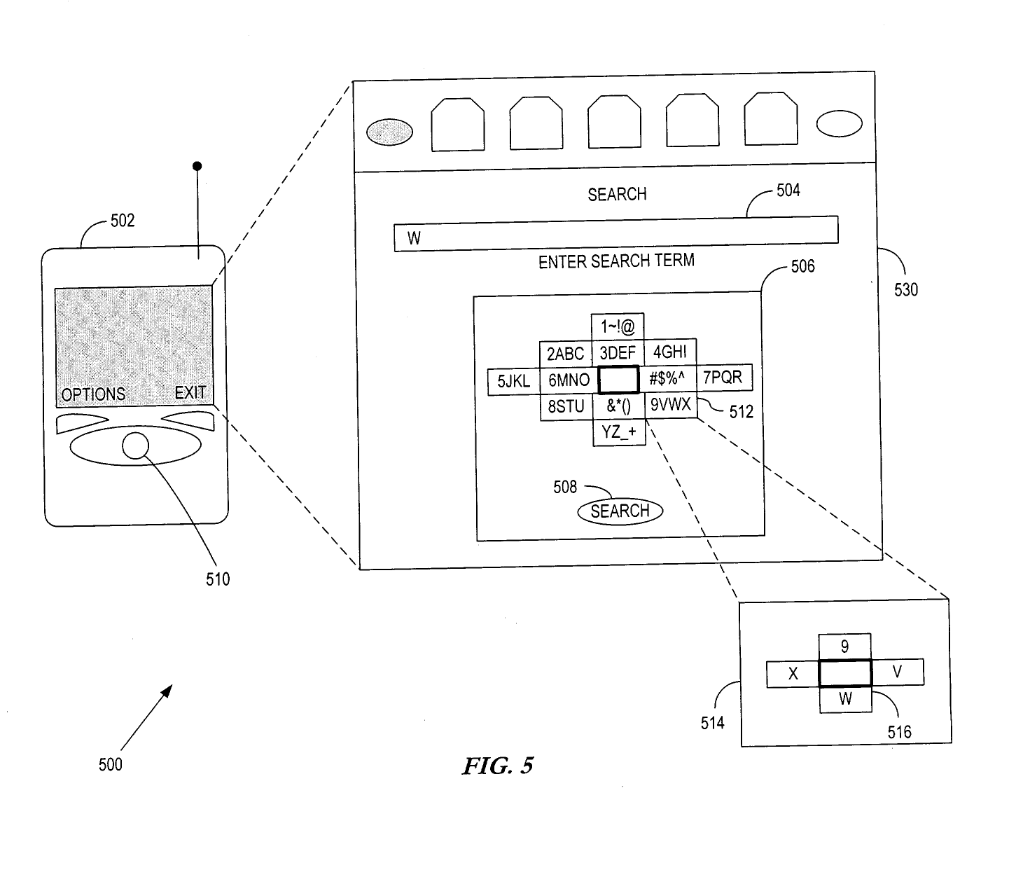

Pre-selection of menu options 404-408 is indicated by the browsing cursor, as illustrated by the darkened borders of pre-selected search menu option 408. Once pre-selected, the user may then activate search menu option 408 by a single depression of joystick 410, which results in display 530 as shown by diagram 500 of FIG. 5. Display 530 of mobile terminal 502 provides the user with virtual keyboard 506, which may be traversed by specific actuations of joystick 510 to supply textual/numerical input to text box 504.

In particular, once virtual keyboard 506 has been instantiated, the default position of the browsing cursor is shown by the highlighted portion of virtual keyboard 506. The user is then able to select portions of virtual keyboard 506 and ultimately select individual characters represented by the portions of virtual keyboard 506, so that characters may be supplied to text box 504. For example, if the user wishes to place a “W” as the first character in text box 504, then one actuation to the right and one actuation downward of joystick 510 is necessary to re-position the browsing cursor from its default position to a position that is over that portion of virtual keyboard 506 that contains the letter “W”, e.g., position 512. Once the browsing cursor is at position 512, a smaller virtual keyboard 514 pops up displaying the 4 available characters of position 512, e.g., “9”, “V”, “W”, and “X”, where the default position of the browsing cursor is indicated by the highlighted portion of virtual keyboard 514. A single downward actuation of joystick 510 re-positions the browsing cursor over position 516, which contains the single character “W”. The user may then activate the “W” character by a single depression of joystick 510, which then results in placing a “W” in the first character position of text box 504. The complete text string can be formed inside text box 504 in like manner and the user may then initiate the search by positioning the browsing cursor over search button 508 through successive directional actuations of joystick 510 followed by an activation, e.g., depression, of joystick 510.

It can be seen, therefore, that Web page navigation, including any textual input that may be required during the browsing session, may be achieved through exclusive use of a joystick controlled mobile terminal according to the principles of the present invention. It should be noted that the navigation frames of FIGS. 3, 4, and 5 are highly configurable to include any number of navigation tabs. For example, on startup of mobile terminal 502, the default home page of the browser may be loaded into the content frame of display 530, while its corresponding navigation tab is highlighted to indicate its activation. The number of other navigation tabs may, for example, be defined from the user's browser configuration. If the number of other navigation tabs equals 4, for example, then 4 other navigation tabs will join the home navigation tab at startup. The URL definitions associated with the navigation tabs may be, for example, taken from the user's bookmark list according to priority, where the top 4 bookmarks are selected.

As the user visits other URLs during the browsing session, navigation tabs may be added to the navigation frame at the user's option, so that they may be revisited at a later time during the browsing session. In this way, back and forward navigation using a combination of joystick input and visual feedback provided by the navigation frame is accomplished. Additionally, the navigation tabs may be labeled automatically by the browser, or optionally by user input, to aid navigation through the navigation tabs. Through the use of the labels, for example, the user may be reminded of the contents of the URL associated with the navigation tab as it is highlighted during pre-selection by the browsing cursor. In one embodiment, the navigation frame and the content frame may be rendered onto separate browser windows. In such an instance, a larger number of navigation tabs could then be accommodated by the separate navigation window. In another embodiment, the navigation frame size may grow adaptively as the user selects URLs of interest, thus causing a corresponding shrinkage of the content frame. Once the content frame has been reduced to a minimum area, the browser may then automatically transition to separate navigation and content windows as required to maximize the display area of both the content and navigation frames. In another embodiment, a scroll bar may be added to the navigation frame, that would allow the user to scroll through the possible navigation tabs using directional commands, once the number of navigation tabs became too large to fit within the navigation frame.

The present invention may also be useful when URL content to be rendered onto the mobile terminal display is larger than the display itself. For example, many of the Web pages, i.e., XHTML/HTML pages, found within Internet 132 of FIG. 1 are mainly designed for larger displays found on desktop computers, fixed Internet terminals, TV monitors, etc. The horizontal and vertical dimensions of these Web pages are usually much larger than Web pages that are specifically designed to fit within the diminutive constraints of a mobile terminal's display. Most of the Web pages can be successfully rendered to fit within the screen size of the mobile terminal by reducing, for example, the resolution or quality of the image or document to be displayed. However, many of the Web pages located within Internet 132 are designed in such a way that it is technically impossible to render the Web pages to the small/narrow mobile terminal display without making the Web page unusable. Similar problems exist with other forms of document/presentation formats such as PDF, Macromedia Flash, SMIL, and SVG to name only a few.

Internet browsers that are designed for small/narrow screens like those found on most mobile terminals usually have, for example, two modes in which content may be displayed. In the first mode, content is rendered to “fit” the width parameters of the mobile terminal's display screen in a way that there is no need for horizontal scrolling. In this mode, the user of the mobile terminal may use the advantages of the present invention to alternate between content frames, i.e., that portion of the document currently viewable on the mobile terminal's display. In particular, the entire Web document may eventually be viewed page by page, by upward or downward actuations, for example, of a joystick.

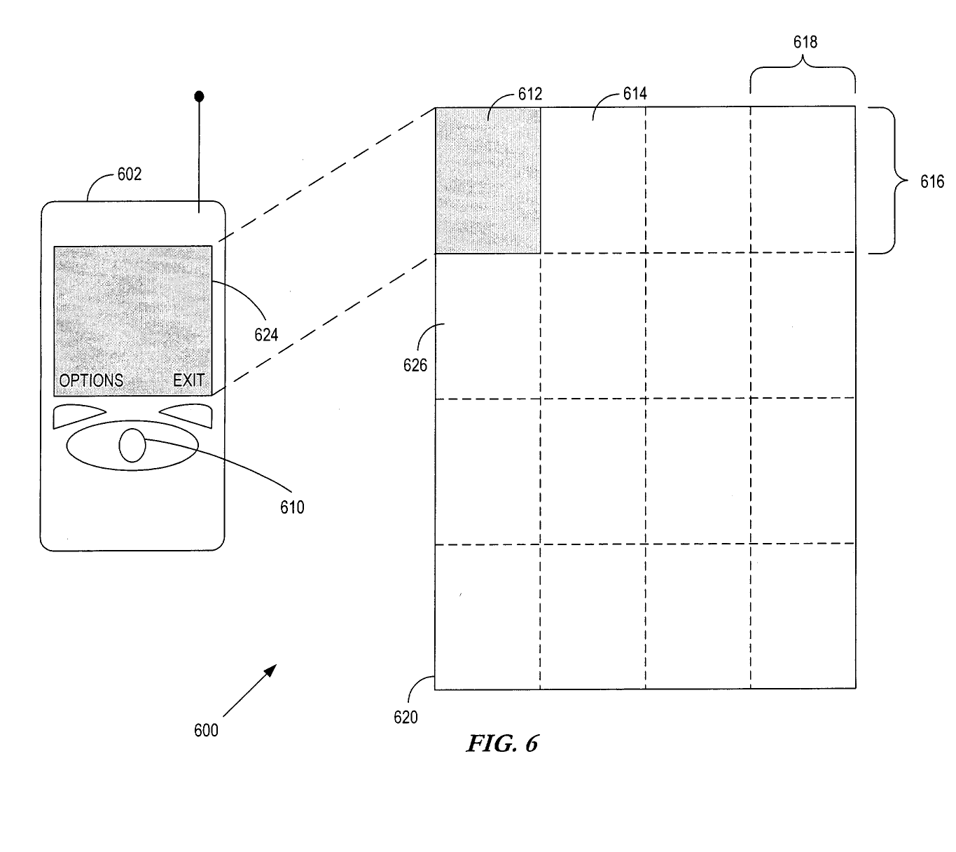

FIG. 6 illustrates exemplary XHTML document rendering 600 that may be navigated in accordance with the present invention, where a first mode of content rendering, or small/narrow screen rendering mode, is presented. In small/narrow screen rendering mode, the markup content is formatted to display 624 in such a way that horizontal scrolling is unnecessary. As can be seen, XHTML document 620 is too large to be entirely rendered onto the display of mobile terminal 602, while maintaining readability and coherency. Thus, the content of XHTML document 620 must be divided into sub-components 614 and then individually rendered onto display 624. It should be noted that although document 620 is described as being defined by XHTML, document 620 may be of any format such as HTML, WML, PDF, Macromedia Flash, SMIL, SVG, etc. that may be accessed by mobile terminal 602. Any XHTML discussion is, therefore, presented for purposes of illustration and is not intended to limit the scope of the present invention in any way.

The small/narrow screen rendering mode divides XHTML document 620 into, for example, 16 sub-components, or frames, 614 of equal, or near equal, dimension. Width dimension 618 and height dimension 616 are sufficiently arranged to “fit” within the content frame of display 624, such that the content of frame 614 may be adequately displayed to be coherent and easily understood.

Navigation between frames 614 may be facilitated through the use of joystick 610 of mobile terminal 602. If frame 612 is the current frame that is rendered to the content frame of display 624, for example, then a single rightward actuation of joystick 610 causes the small/narrow screen rendering mode to display the contents of frame 614. Similarly, a single downward actuation of joystick 610 results in the rendering of frame 626 onto the content frame of display 624. Once the user has located a frame of interest, a single depression of joystick 610 results in freezing the frame in preparation for hyperlink navigation mode discussed below.

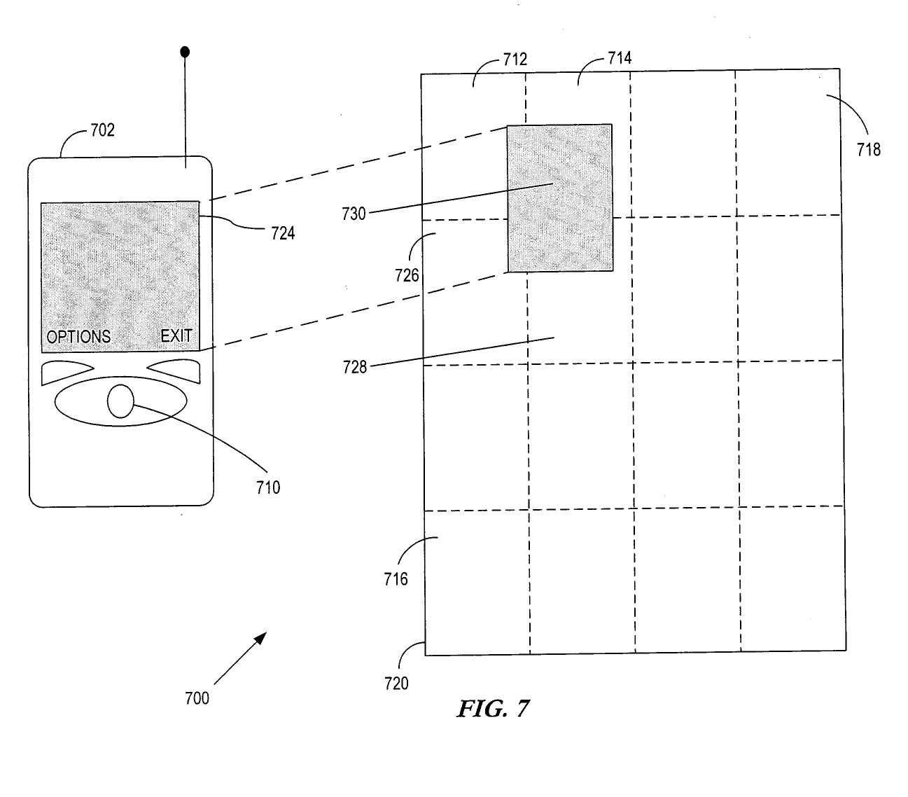

FIG. 7 illustrates alternative XHTML document rendering 700 that may also be navigated in accordance with the present invention, where a second mode of content rendering, or normal rendering mode, is presented. In normal rendering mode, the markup content is formatted to display 724 in such a way that horizontal and vertical scrolling are both necessary. As can be seen, XHTML document 720 is too large to be entirely rendered onto the display of mobile terminal 702, while maintaining readability and coherency. Thus, content on XHTML page 720 must be rendered in accordance with scrolling frame 730.

Initially, scrolling frame 730 originates in position 712 of XHTML page 720, where the contents of frame 712 are rendered onto display 724 in accordance with the content frame defined by display 724. Navigation to other portions of XHTML page 720 do not occur on frame boundaries, as defined for example by frames 712, 714, 726, and 728, but rather occurs by sliding the scrolling frame 730 across XHTML page 720 using a series of joystick actuations.

If frame 712 is the current frame that is rendered to the content frame of display 724, for example, then a single rightward actuation of joystick 710 causes scrolling frame 730 to move one increment to the right. Similarly, a single downward actuation of joystick 710 results in moving scrolling frame 730 by one increment downward. The definition of a single increment may be predetermined by the user through the use of a configuration screen to have any number of different meanings. In one embodiment, the user may define an increment to be some fraction of one dimension of display 724. If left/right movements of joystick 710 are actuated for example, scrolling window 730 may be configured to change by 10% of the total horizontal distance defined by display 724. Alternately, if up/down movements of joystick 710 are actuated, scrolling window 730 may be configured to change by 10% of the total vertical distance defined by display 724.

The current position of scrolling window 730 is illustrated to overlap frames 712, 714, 726, and 728 as shown in FIG. 7. Accordingly, the vertical rectangle of display 724 displays the lower right corner of frame 712, the majority of the lower portion of frame 714, the upper right corner of frame 726, and the majority of an upper portion of frame 728. Once the user has defined an acceptable position of scrolling frame 730, a single depression of joystick 710 results in freezing scrolling frame 730 in its current position in preparation for hyperlink navigation mode discussed below.

The user may slide scrolling window 730 to virtually any position located within XHTML page 720 using joystick command input. Once scrolling window 730 has reached either the left, right, top, or bottom boundary of XHTML page 720, then scrolling window 730 may reset itself to the opposite boundary to prepare for the next scrolling pass. For example, if frame 712 is the origin of scrolling window 730 during navigation in normal rendering mode, then enough downward movements of scrolling window 730 causes it to completely overlap frame 716. One more successive downward movement may cause scrolling window 730 to automatically reposition itself to the position defined by frame 714 and the user may continue his or her downward sliding of scrolling window 730. Alternatively, if frame 712 is the origin of scrolling window 730 during navigation in normal rendering mode, then enough rightward movements of scrolling window 730 causes it to completely overlap frame 718. One more successive rightward movement may cause scrolling window 730 to automatically reposition itself to the position defined by frame 726 and the user may continue his or her rightward sliding of scrolling window 730.

In another embodiment, instead of automatically re-positioning scrolling window 730, control may be given to the user by highlighting a scroll bar (not shown) within the navigation window of display 724. In this way, the user may position scrolling window 730 at any position within display 720 once scrolling window 730 is scrolled to any edge of display 720. Alternatively, the scroll bar (not shown) may also be activated, for example, by an extended depression of joystick 710 or a double depression of joystick 710.

Once the content frame of the user's mobile terminal displays interesting content, the user may freeze the frame currently displayed and may enter hyperlink navigation mode. Hyperlink navigation mode may be entered, for example, by a single depression of the joystick, once the user has located a frame of interest having one or more hyperlinks or “hot spots” where user interaction is required.

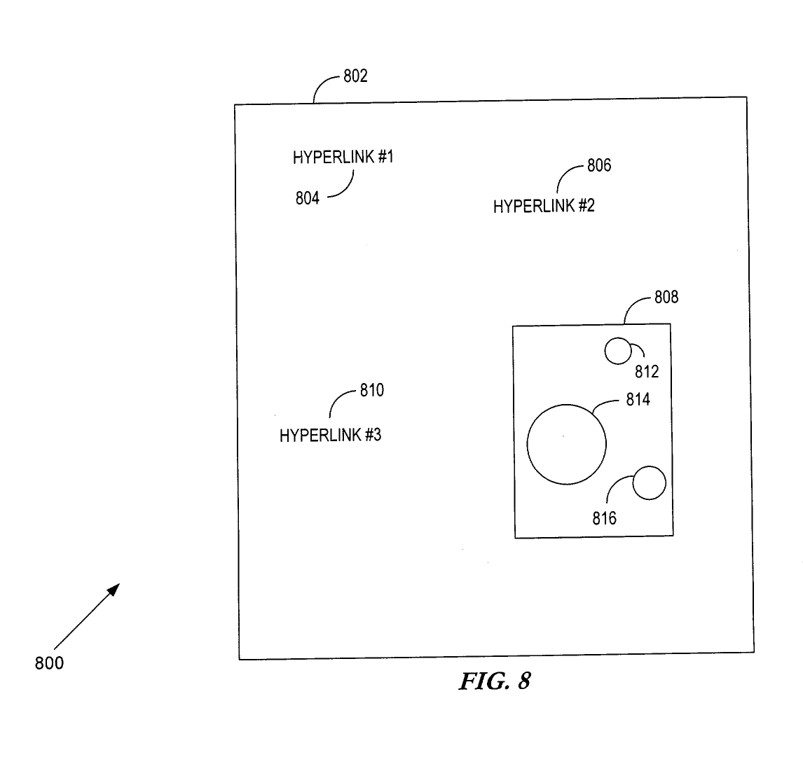

FIG. 8 illustrates exemplary content 800 that may be displayed by content frame 802 once the user has entered hyperlink navigation mode. Exemplary content 800 contains hyperlinks 804, 806, and 810, as well as image map 808 having hot spot regions 812-816 defined within. Ordinarily, users of mobile terminals having pointing capability would easily be able to select any one of the hyperlink/hot spot regions defined within content frame 802. Users of mobile terminals without such pointing capability, however, require the advantages of the present invention to select the hyperlink/hot spot regions of interest.

In one embodiment according to the present invention, hyperlink 804 may be highlighted once hyperlink navigation mode has been entered, in order to signify that hyperlink 804 is the currently pre-selected hyperlink associated with content frame 802. Upon a single depression of the joystick, for example, the URL associated with hyperlink 804 would be contacted by the browser contained within the user's mobile terminal, and the content defined by the URL would then be rendered onto the display of the user's terminal.

Alternatively, the user may wish to pre-select one of the remaining hyperlinks/hot spots contained within content frame 802. In particular, if hyperlink 804 is the current pre-selected link, then a single rightward actuation of the joystick causes the hyperlink/hot spot navigation mode to highlight hyperlink 806 as the currently pre-selected link. Similarly, a downward actuation of the joystick results in the highlighting of hyperlink 810 as the currently pre-selected link. Successive actuations of the joystick will cycle through each of hot spots 812, 814, and 816, causing each to be visually highlighted, since they represent XHTML images and associated hyperlinks. Once the user has located a hyperlink/hot spot of interest, a single depression of the joystick causes the mobile terminal's browser to contact the URL associated with the hyperlink/hot spot to subsequently render the URL's contents onto the display of the mobile terminal.

An exemplary code sequence that generates the hyperlinks and hot spots displayed by content frame 802 is illustrated in code sequence (1). It can be seen that each hyperlink is established with an anchor tag, i.e., “a” tag, that is used to create an anchor from content frame 802, and an “href” attribute used to address the document to link to, e.g., HYPERLINK #1 links to “http://www.hyperlink1.com/”. Similarly, image map 808 is created having, for example, images of the sun 814, mercury 812, and venus 816, where each planet/star image is itself a hyperlink, e.g., href=“ . . . /images/planets/sun.htm” creates a hyperlink to the file that defines the image of the sun.

The mobile browser executing within the mobile terminal, for example, need only locate the “href” attributes within code sequence (1) when the user is using hyperlink navigation mode. For example, if hyperlink 804 in content frame 802 is currently pre-selected, then the browser knows that “http://www.hyperlink1.com/” is the corresponding URL. A subsequent rightward actuation of the joystick would cause the browser to search code sequence (1) for the next occurrence of keyword “href”.

| | |
|---|---|
| <!DOCTYPE html | (1) |

PUBLIC “-//W3C//DTD XHTML 1.0 Strict//EN”
“http://www.w3.org/TR/xhtml1/DTD/xhtml1-strict.dtd”>
<html>
<body>
<p>
<a href=“http://www.hyperlink1.com/”>
HYPERLINK #1</a>
</p>
<p>
<a href=“http://www.hyperlink2.com/”>
HYPERLINK #2</a>
</p>
<p>
<a href=“http://www.hyperlink3.com/”>
HYPERLINK #3</a>
</p>
<img src=“../images/circles.gif”
width=“125” height=“145”
usemap=“#planetmap”>
<map id=“planetmap” name=“planetmap”>
<area shape=“rect”
coords=“0,0,82,126”
alt=“Sun”
href=“../images/planets/sun.htm”>
<area shape=“circle”
coords=“90,58,3”
alt=“Mercury”
href=“../images/planets/mercur.htm”>
<area shape=“circle”
coords=“124,58,8”
alt=“Venus”
href=“../images/planets/venus.htm”>
</map>
</body>
</html>

The browser could then determine that “http://www.hyperlink2.com/” is the next corresponding URL. Accordingly, any code sequence that defines contents of content frame 802 may likewise be parsed and identified for hyperlinks while the user is navigating in hyperlink navigation mode. It is apparent to one of ordinary skill in the art that parsing and identification of markup language may be done in any number of different ways. Accordingly, the above description is merely one embodiment used for description purposes only and is not intended to limit the scope of the invention in any way.

Once hyperlink navigation mode has been activated, the user may transition back to either the small/narrow screen rendering mode or the normal rendering mode in several different ways. In one embodiment, once the user has highlighted, for example, either hyperlink 804 or image 816, the browser is aware that these hyperlinks represent either the first or the last hyperlink that is viewable within content frame 802. If the user then generates a navigation command that causes the browser to reach, for example, the beginning or the end of code sequence (1) in search for another keyword such as “href”, then the browser automatically transitions back to frame scrolling mode defined by either of the small/narrow screen or normal rendering modes discussed above. Alternately, in the event that the content of the Web page fits within the content frame of the mobile terminal's display, then frame scrolling is not necessary and hyperlink navigation mode remains the active navigation mode.

In another embodiment, once the user has highlighted, for example, either hyperlink 804 or image 816, the browser is aware that these hyperlinks represent either the first or the last hyperlink that is viewable within content frame 802. If the user then generates a navigation command that causes the browser to reach, for example, the beginning or the end of code sequence (1) in search for another keyword such as “href”, the browser then automatically circles back to either the beginning or end of code sequence (1). For example, if the currently pre-selected hyperlink/hot spot is hyperlink 816, then a subsequent downward actuation of the joystick causes the browser to circle back around to hyperlink 804 to make it the currently pre-selected hyperlink. Alternatively, if the currently pre-selected hyperlink/hot spot is hyperlink 804, then a subsequent upward actuation of the joystick causes the browser to circle back around to hyperlink 816 to make it the currently pre-selected hyperlink. In this fashion, the user remains in a circular hyperlink navigation mode until commanded to leave circular hyperlink navigation mode. In one embodiment, the user may leave circular hyperlink navigation mode by depressing the joystick for a longer period of time than normal. The required period of time necessary to transition from hyperlink navigation mode to frame scrolling mode is configurable and may be selected, for example, by the user via a configuration screen or at the time of provisioning the mobile terminal.

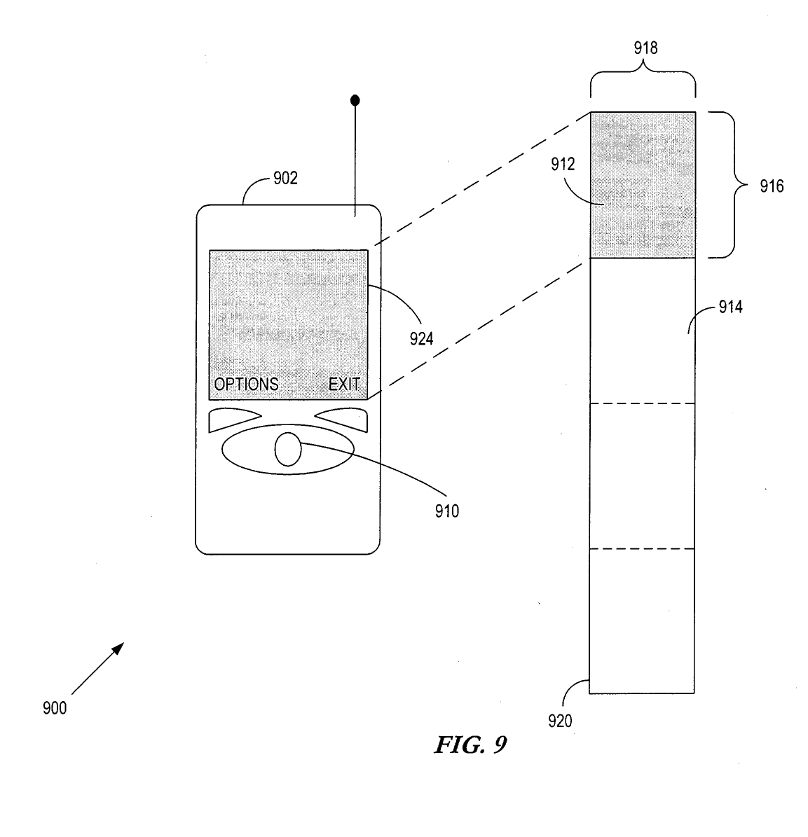

FIG. 9 illustrates alternate rendering 900, whereby frames 914 are rendered to completely fit within display 924 and horizontal scrolling is unnecessary. As can be seen, XHTML document 920 is too long to be entirely rendered onto the display of mobile terminal 902, while maintaining readability and coherency. Thus, the content of XHTML document 920 must be divided into sub-components 914 and then individually rendered onto display 924. The rendering mode divides XHTML document 920 into, for example, 4 sub-components, or frames, 914 of equal, or near equal, dimension. Width dimension 918 and height dimension 916 are sufficiently arranged to “fit” within the content frame of display 924, such that the content of frames 914 may be adequately displayed to be coherent and easily understood.

Navigation between frames 914 may be facilitated through the use of joystick 910 of mobile terminal 902. If frame 912 is the current frame that is rendered to the content frame of display 924, for example, then a single downward actuation of joystick 910 results in the rendering of frame 914 onto the content frame of display 924. Once the user has located a frame of interest, a single depression of joystick 910 results in freezing the frame in preparation for hyperlink navigation mode.

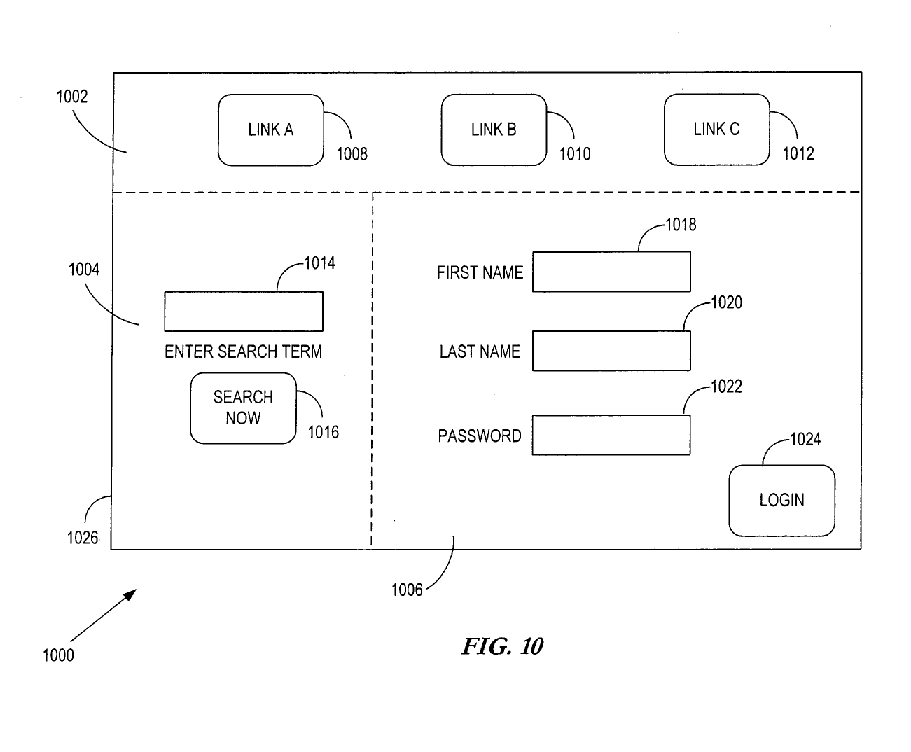

In an alternate embodiment as illustrated by screen 1000 of FIG. 10, the entire Web page may fit within the viewing rectangle of the mobile terminal, where the Web page frequently contains navigational links, e.g., 1008-1012, search fields, e.g., 1014-1016, and login screens, e.g., 1018-1022. Screen 1026 is partitioned into three areas: 1002; 1004; and 1006. Frame 1002 represents an area containing navigational links that may be followed from screen 1026. Link A 1008, Link B 1010, and Link C 1012 represent navigational links contained within navigational area 1002 that, when selected, causes the browser to fetch the home page contents of the URL that corresponds to those links. Frame 1004 represents a typical search partition found on many Web pages that allows the user to search for terms that may exist within the URL's domain. Search terms may be entered by the user into input block 1014 and then searched for by selecting the “Search Now” button 1016. Frame 1006 represents a typical login screen partition that allows special users to authenticate themselves by entering their first name in input block 1018, their last name in input block 1020, and a password in input block 1022. Once all of the the information is entered, the user's validation may take place by selecting the “Login” button 1024.

A typical XHTML code sequence that may be used to define areas 1002-1006 is presented in code sequence (2) below:

| <html xmlns=“http://www.w3.org/1999/xhtml”> | |
|---|---|
| <frameset rows=“25%,75%”> | |
| <frame src=“frame_1002.htm” /> | |
| <frameset cols=“40%,60%”> | |
| <frame src=“frame_1004.htm” /> | (2) |

```
    <frame src=“frame_1006.htm” />
  </frameset>
</frameset>
</html>
```

Code sequence (2) defines two horizontal areas by using the first frameset tag followed by attribute values for each of the two rows in the frame set. The first horizontal area defined by frame 1002 claims 25% of the total area of the frameset, whereas the second horizontal area, defined by frames 1004 and 1006, claims 75% of the total area of the frame set. Within the second of the two horizontal areas, two columns are defined by the second frameset tag by setting attribute values for the two columns, e.g., 1004 and 1006, of the second horizontal area to 40% and 60%, respectively. Thus, frame 1004 comprises 40% of the second horizontal area and frame 1006 comprises 60% of the second horizontal area. The contents of each of the framesets defined by code sequence (2) are further defined by HTML files: frame_{—}1002.htm; frame_{—}1004.htm; and frame_{—}1006.htm; and they contain HTML code known in the art to generate frames 1002, 1004, and 1006, respectively. It can be said, therefore, that the three frames defined by code sequence (2) are all opened within the same browser window.

Screen 1026 fits within the size constraints of the mobile device's display. As a result, the user is able to navigate within the elements of screen 1026 by using directional inputs. In other words, each of elements 1008-1024 of screen 1026 may be individually pre-selected by the mobile device, simply by navigating through each element in sequential manner. As each element is selected, it is highlighted or centered on the display of the mobile device so that the user knows which element is pre-selected at any given time. Once pre-selected, the user may activate the object, for example, by depressing the joystick.

Alternately, frames 1002-1006 may each be individually highlighted through the use of directional input commands. As each directional input from, for example, a joystick is sensed, then the corresponding frame associated with the navigational input is highlighted to indicate its pre-selection status. Directional input from the joystick may also be construed by the mobile terminal as zoom control. For example, once one of frames 1002-1006 has been pre-selected, then an additional depression of the joystick may cause the zoom function to render the frame such that it occupies an increasingly larger portion of the viewing rectangle of the mobile terminal.

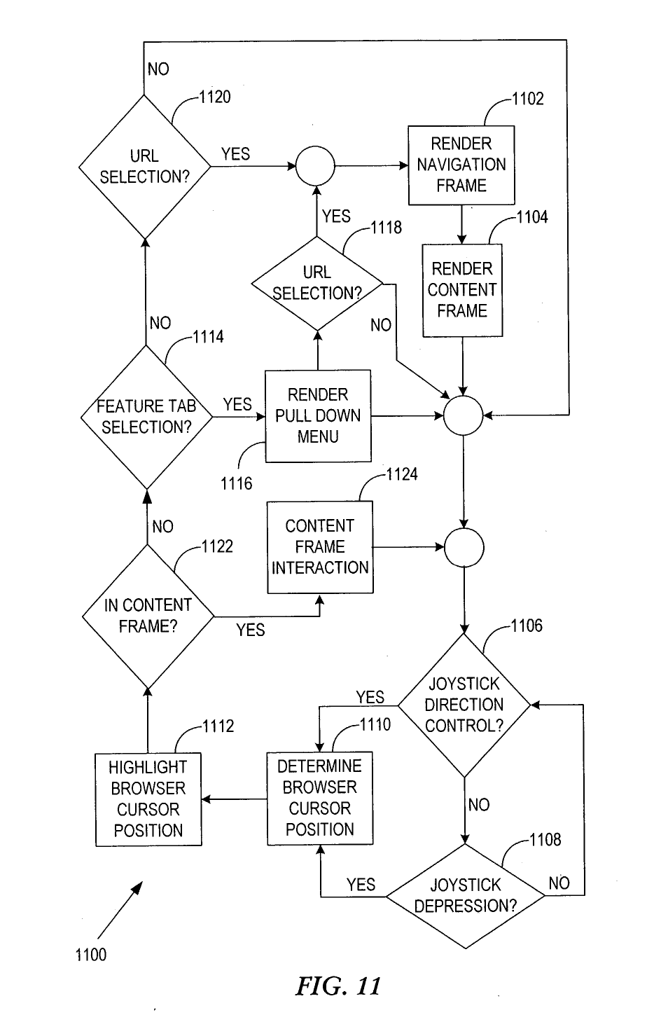

A method according to the principles of the present invention is illustrated by the exemplary flow diagram of FIG. 11. After startup of the mobile terminal, the navigation frame is rendered in step 1102 and the content frame is rendered in step 1104. The navigation and content frames are rendered in accordance with the predetermined configuration of the default navigation and content frames. In one embodiment, for example, the user may have configured the browser to render a total of 5 navigation tabs as illustrated in FIGS. 3-5, where the first of the five navigation tabs corresponds to the user's default home page and is slightly shaded, or discolored, to indicate its currently active state. Likewise, the content frame displays the entire contents of the user's home page, or a portion of the user's home page, as illustrated in FIGS. 6-9. The remaining navigation tabs may relate, for example, to the highest priority bookmarks as defined by the user's browser configuration.

In steps 1106 and 1108, joystick movement is detected. Whether joystick direction control of step 1106 or joystick depression of step 1108 has been detected, a determination of the browser cursor position is determined in step 1110. The browser cursor position may then be highlighted in step 1112 if joystick direction control was detected, to allow the user to immediately determine the current state of navigation control. In step 1122, a determination is made as to whether the position of the browsing cursor is within the content window. If so, then the user is interacting with the content frame in step 1124 as illustrated, for example, by FIG. 8 or 10.

If the user is not interacting with the content frame and is instead navigating in the navigation frame, then in step 1114 a determination is made as to whether a depression of the joystick has occurred at a position occupied by a feature tab. If it has, then a pull down menu is rendered in step 1116 to provide the user with additional execution options. It should be noted that although a pull down menu results in the selection of the feature tab, one of ordinary skill in the art will appreciate that any GUI reaction may result from the user's selection of a feature tab. For example, a completely new content frame may be rendered from a new URL having a variety of interactive components requiring further user input as in step 1118. Additionally, the user may have selected a bookmark, or manually typed in a URL from the pull down menu to cause a URL selection determination in step 1118.

If no feature tab was selected, then a determination is made as to whether a URL selection was made from a navigation tab in step 1120. In such an instance, the browser fetches content from the URL associated with the navigation tab, renders the content on the content frame, and shades, or discolors, the navigation tab to indicate its current activation.

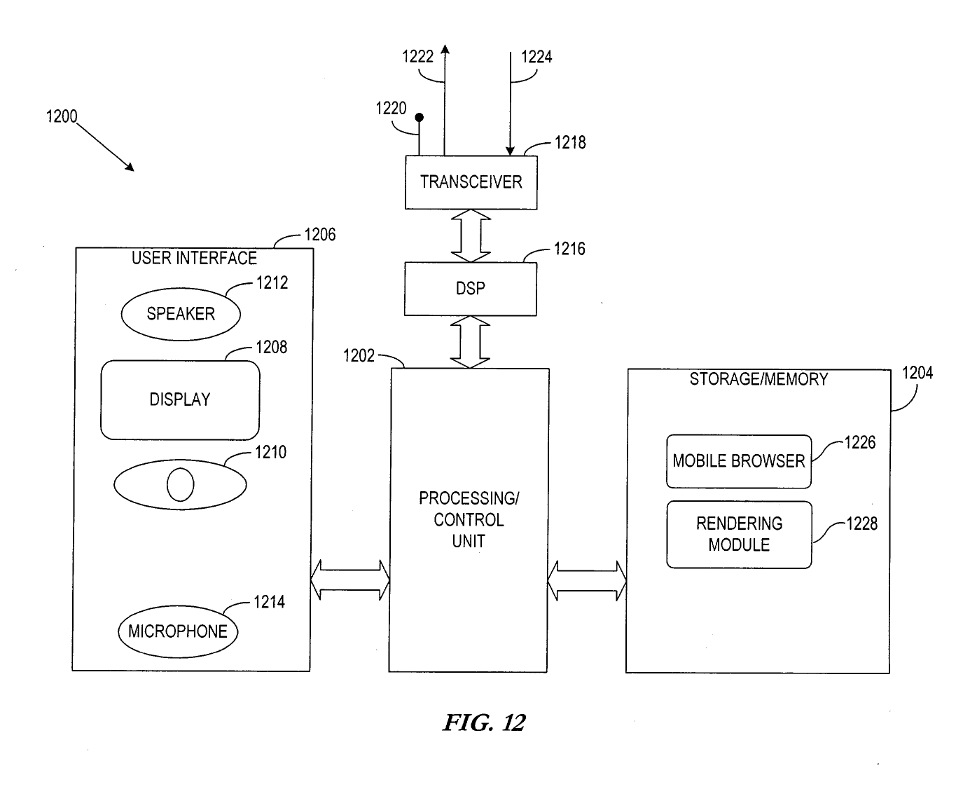

The invention is a modular invention, whereby processing functions within a mobile terminal may be utilized to implement the present invention. The mobile devices may be any type of wireless device, such as wireless/cellular telephones, PDAs, or other wireless handsets, as well as portable computing devices capable of wireless communication. These mobile devices utilize computing circuitry and software to control and manage the conventional device activity as well as the functionality provided by the present invention. Hardware, firmware, software or a combination thereof may be used to perform the various browsing functions described herein. An example of a representative mobile terminal computing system capable of carrying out operations in accordance with the invention is illustrated in FIG. 12. Those skilled in the art will appreciate that the exemplary mobile computing environment 1200 is merely representative of general functions that may be associated with such mobile devices, and also that landline computing systems similarly include computing circuitry to perform such operations.

The exemplary mobile computing arrangement 1200 suitable for facilitating browsing functions in accordance with the present invention may be associated with a number of different types of wireless devices. The representative mobile computing arrangement 1200 includes a processing/control unit 1202, such as a microprocessor, reduced instruction set computer (RISC), or other central processing module. The processing unit 1202 need not be a single device, and may include one or more processors. For example, the processing unit may include a master processor and associated slave processors coupled to communicate with the master processor.

The processing unit 1202 controls the basic functions of the mobile terminal, and also those functions associated with the present invention as dictated by mobile browser 1226 and rendering module 1228 available in the program storage/memory 1204. Thus, the processing unit 1202 is capable of accessing markup content using mobile browser 1226 and navigating the content through the use of navigation and content frames rendered by rendering module 1228. The program storage/memory 1204 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 1204 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 1200 via data signals, such as being downloaded electronically via one or more networks, such as the Internet and an intermediate wireless network(s).

The processor 1202 is also coupled to user-interface 1206 elements associated with the mobile terminal. The user-interface 1206 of the mobile terminal may include, for example, a display 1208 such as a liquid crystal display, a joystick 1210, speaker 1212, and microphone 1214, as well as keyboard control (not shown). These and other user-interface components are coupled to the processor 1202 as is known in the art.

The mobile computing arrangement 1200 also includes conventional circuitry for performing wireless transmissions. A digital signal processor (DSP) 1216 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 1218, generally coupled to an antenna 1220, transmits the outgoing radio signals 1222 and receives the incoming radio signals 1224 associated with the wireless device.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a browsing system, apparatus, and method in accordance with the present invention.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A network browsing system, comprising:
a network having Web pages addressable by a Uniform Resource Locator (URL); and
a mobile terminal coupled to the network, the mobile terminal comprising:
a mobile browser coupled to receive markup definitions associated with the Web pages and arranged to generate content frames from the markup definitions and navigation tabs corresponding to the content frames; and
a navigational device coupled to the mobile browser, wherein directional inputs from the navigational device pre-select the navigation tabs and depression inputs from the navigational device activates the content frames.

2. The network browsing system according to claim 1, wherein a single directional actuation from the navigational device pre-selects a different navigation tab.

3. The network browsing system according to claim 2, wherein a first visual indication is used to indicate the pre-selected status of the navigation tabs.

4. The network browsing system according to claim 3, wherein a single depression input from the navigational device activates the corresponding content frame.

5. The network browsing system according to claim 4, wherein a second visual indication is used to indicate the activated status of the navigation tabs.

6. The network browsing system according to claim 1, wherein the mobile terminal generates an additional navigation tab for each Web page visited.

7. The network browsing system according to claim 1, wherein the navigational device facilitates textual input interaction with the content frames.

8. A mobile terminal wirelessly coupled to a network having Web pages accessible by a Uniform Resource Locator (URL), the mobile terminal comprising:
a memory capable of storing at least one of a mobile browser and a rendering module;
a transceiver configured by the mobile browser to facilitate markup language exchange with a plurality of Web pages;
a processor coupled to the memory and configured to render navigation tabs corresponding to the Web pages; and
a navigation device coupled to pre-select the navigation tabs using directional input and coupled to activate the Web pages with depression input.

9. The mobile terminal according to claim 8, wherein the processor is configured to render the navigation tabs into a navigation frame and configured to render activated Web pages into a content frame.

10. The mobile terminal according to claim 9, wherein multiple content frames are rendered when the Web page is larger than a display area of the mobile terminal.

11. The mobile terminal according to claim 10, wherein the multiple content frames are predetermined.

12. The mobile terminal according to claim 11, wherein directional input from the navigational device pre-selects the content frames.

13. The mobile terminal according to claim 12, wherein depression input from the navigational device activates hyperlink navigation within the content frames.

14. The mobile terminal according to claim 10, wherein the multiple content frames are determined incrementally by defining a scrolling window.

15. The mobile terminal according to claim 14, wherein directional input from the navigational device determines a position of the scrolling window.

16. The mobile terminal according to claim 15, wherein depression input from the navigational device activates the scrolling window for hyperlink navigation.

17. A computer-readable medium having instructions stored thereon which are executable by a mobile terminal for facilitating browser navigation by performing steps comprising:
receiving documents containing hyperlinks;
generating a navigation frame to display navigation tabs relating to the documents;
generating a content frame to display content relating to the navigation tabs; and
navigating within the navigation and content frames, wherein pre-select feedback corresponding to directional input is provided and activation feedback is provided corresponding to selection input.

18. The computer-readable medium according to claim 17, wherein the instructions allow joystick control of the directional and selection input.

19. The computer-readable medium according to claim 17, wherein the instructions allow joystick control of textual input.

20. A method for facilitating joystick navigation on a mobile terminal, comprising:
detecting direction and depression inputs from a joystick;
correlating the joystick inputs with a relative position on a browser window;
interpreting the joystick inputs as navigational when correlated to a first portion of the browser window; and
interpreting the joystick inputs as interactive when correlated to a second portion of the browser window.

21. The method according to claim 20, wherein the first portion of the browser window corresponds to a navigation frame.

22. The method according to claim 21, wherein navigation tabs within the navigation frame are pre-selected using directional joystick inputs.

23. The method according to claim 22, wherein navigation tabs within the navigation frame are activated using depression joystick inputs.

24. The method according to claim 23, wherein the second portion of the browser window allows joystick interaction in response to activation of the navigation tab.

25. The method according to claim 24, wherein joystick interaction in the second portion of the browser window comprises:
facilitating textual input; and
navigating between hyperlinks.
